(19) United States
(12) Patent Application Publication
(10) Pub. No.: US 2020/0211192 A1
(43) Pub. Date: Jul. 2, 2020

(54) METHOD AND SYSTEM FOR GENERATING A STRUCTURE MAP FOR RETINAL IMAGES

(71) Applicant: SIGTUPLE TECHNOLOGIES PRIVATE LIMITED, Bangalore (IN)

(72) Inventors: Maroof Ahmad, Singrauli (IN); Tathagato Rai Dastidar, Bangalore (IN)

(73) Assignee: SIGTUPLE TECHNOLOGIES PRIVATE LIMITED, Bangalore (IN)

(21) Appl. No.: 16/725,949

(22) Filed: Dec. 23, 2019

(30) Foreign Application Priority Data
Dec. 27, 2018 (IN) 201841049496

(51) Int. Cl. G06T 7/00; G06N 3/04; G06N 3/08

(52) U.S. Cl. CPC G06T 7/0014; G06N 3/04; G06T 2207/30041; G06T 2207/20081; G06T 2207/20084; G06N 3/08

(57) ABSTRACT

The present disclosure provides method and system for generating a structure map for retinal images. The system receives one or more retinal images and extracts or more structures in the retinal images. The system identifies one or more gradable retinal images among the one the retinal images. The system identifies one or more structure types and condition states in each of identified gradable retinal images based on extracted one or more structures and information associated with pre-learnt structures in pre-stored gradable retinal images using a Convolution Neural Network (CNN). The CNN is trained using information associated with pre-learnt structures in pre-stored gradable retinal images. The system generates structure map indicating one or more structure types for the gradable retinal images. The present disclosure provides accurate way of identifying structure types and condition states and hence avoids Inter-Observer Variability (IOV) between ophthalmologists in annotating structure types and condition states.

### CROSS-REFERENCE TO RELATED APPLICATIONS

This application claims priority to and the benefit of Indian Application No. 201841049496, filed Dec. 27, 2018, the contents of which is herein incorporated by reference.

### TECHNICAL FIELD

The present subject matter is generally related to image processing and more particularly, but not exclusively, to method and system for generating a structure map for retinal images.

### BACKGROUND

Retinal images are used for identifying condition states such as Diabetic Retinopathy (DR) and Age-Related Macular Degeneration (ARMD) among other health conditions. The other condition states such as Diabetic Macular Edema (DME) may also be identified using fundus and Optical coherence tomography (OCT) scans.

The condition states may be further classified into sub-stages based on type of structures present, which are the baseline for further analysis. Many Convolution Neural Network (CNN) based approaches have been proposed for the classification of severity of these condition states, as it has outperformed the classical image-analysis method. These methods may be divided into image-based and pathology-based CNN models. The unavailability of structure information in the image-based CNN classification methods have resulted in the use of pathological based methods to build pathological based models in which ophthalmologists annotates the structures. However, such models have high Inter-Observer Variability (IOV) between ophthalmologists and hence may not be accurate.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present disclosure provides a method for generating a structure map for retinal images. The method comprises receiving, by a structure map generation system, one or more retinal images and extracting one or more structures in each of the one or more retinal images. The method as also comprises identifying one or more gradable retinal images among the one or more retinal images. Once the one or more gradable retinal images are identified, the method comprises identifying one or more structure types in each of the identified one or more gradable retinal images based on the extracted one or more structures and information associated with pre-learnt structures in the pre-stored gradable retinal images. Thereafter, the method comprises generating a structure map indicating the one or more structure types for each of the one or more gradable retinal images.

The present disclosure provides a structure map generation system for generating a structure map for retinal images. The structure map generation system comprises a processor and a memory communicatively coupled to the processor. The memory stores the processor-executable instructions, which, on execution, causes the processor to receive one or more retinal images and extract one or more structures in each of the one or more retinal images. Thereafter, the processor identifies one or more gradable retinal images among the one or more retinal images. Once the one or more gradable retinal images are identified, the processor identifies one or more structure types in each of the identified one or more gradable retinal images based on the one or more structures and information associated with pre-learnt structures in the pre-stored gradable retinal images. Thereafter, the processor generates a structure map indicating the one or more structure types for each of the one or more gradable retinal images.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the leftmost digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for generating a structure map for retinal images in accordance with some embodiments of the present disclosure;

FIGS. 2a-c show a block diagram of a structure map generation system in accordance with some embodiments of the present disclosure;

FIG. 3 shows a flowchart illustrating a method for generating a structure map for retinal images in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, “including” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a structure map generation system (also referred as system) for generating structure map for retinal images. The system may receive one or more retinal images for screening and extracting one or more structures in each of the one or more retinal images. The one or more structures may help in identifying structure types and condition states in the retinal images. In an embodiment, image may be processed using predefined image processing techniques to extract one or more structures. Thereafter, the system may identify one or more gradable retinal images using image gradability model. As an example, the image gradability model may include, but is not limited to, Liquid Time Constant Recurrent Neural Networks (LTCNet) model. The one or more gradable retinal images may be the images with good quality in terms of color, contrast, illumination and focus and which can be considered for further processing. The one or more gradable retinal images may be identified based on quality of the retinal images. Once the one or more gradable retinal images are identified, the system may identify one or more structure types in each of the identified one or more gradable retinal images based on the extracted one or more structures and information associated with pre-learnt structures in the pre-stored gradable retinal images. The information may comprise one or more pre-stored gradable retinal images, one or more structure types and one or more condition states associated with pre-learnt structures in the one or more pre-stored gradable retinal images. In an embodiment, the system may identify the one or more structure types and the one or more condition states in each of the one or more gradable retinal images using a Convolutional Neural Network (CNN). The CNN may be trained using the information associated with the pre-learnt structures in the one or more pre-stored gradable retinal images. Thereafter, the system may generate a structure map which indicates the one or more structure types for each of the one or more gradable retinal images. The present disclosure provides an accurate way of identifying structure types and condition states using CNN and hence avoids Inter-Observer Variability (IOV) between ophthalmologists who annotates structure types and condition states.

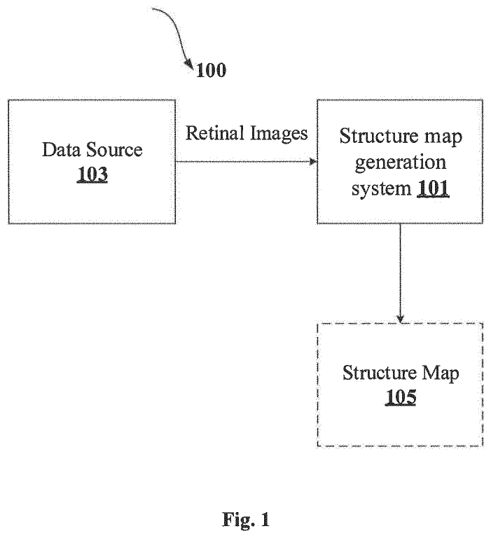

FIG. 1 shows an exemplary environment for generating a structure map for retinal images in accordance with some embodiments of the present disclosure.

In some implementations, the exemplary architecture 100 may comprise a data source 103 and a structure map generation system 101 [also referred as system]. The data source 103 may store one or more retinal images of a subject. The structure map generation system 101 may receive one or more retinal images from the data source 103 for screening of the one or more retinal images. The one or more retinal images may also be obtained from a device associated with the system 101 wherein the device captures the retinal images. The screening may be performed to identify one or more structure types and one or more condition states in the one or more retinal images. The one or more structure types may be type of one or more structures or features which indicate presence of lesions in the retinal image. As an example, the one or more structure types may include, but is not limited to, Microaneurysms, deep-hemorrhage, Hard Exudates and Soft Exudates. The one or more condition states may be disease types associated with the retinal image. As an example, the one or more condition states may include, but is not limited to, Diabetic Retinopathy (DR), Age-Related Macular Degeneration (ARMD) and Diabetic Macular Edema (DME). In an embodiment, upon receiving the one or more retinal images, the system 101, may extract one or more structures in each of the one or more retinal images. The one or more retinal images may be processed using a predefined image processing technique to generate a normalised image. The normalised image may comprise the one or more structures. The one or more structures may indicate one or more lesion features. In an embodiment, the system 101 may identify one or more gradable retinal images among the one or more retinal images. The one or more gradable retinal images may be the images with good quality in terms of color, contrast, illumination and focus. The one or more gradable retinal images may be used for further processing and one or more non-gradable retinal images may be discarded. Upon identifying the one or more gradable retinal images, the system 101 may identify one or more structure types in each of the identified one or more gradable retinal images. The one or more structure types may be identified based on the extracted one or more structures and information associated with pre-learnt structures in pre-stored gradable retinal images. The system 101 may implement a CNN technique for identifying the one or more structure types in the identified one or more gradable retinal images.

In an embodiment, an annotator may annotate structure types and condition states for one or more gradable retinal images. As an example, annotation may refer to indicating information associated with structure types and condition states. The annotated one or more gradable images may be stored as pre-stored gradable retinal images in the structure map generation system 101. As an example, the annotator may be an ophthalmologist. In an embodiment, the system 101 may implement a Convolution Neural Network (CNN) which is trained using information associated with pre-learnt structures and pre-learnt condition states in the pre-stored gradable retinal images. Once the CNN is trained, the CNN may be used to identify one or more structure types and one or more condition states in each of the identified one or more gradable retinal images in real-time. The CNN may identify the one or more structure types and one or more condition states based on the extracted one or more structures and the information associated with the pre-learnt structures and pre-learnt condition states in the pre-stored retinal images.

In an embodiment, the system 101 may identify degree of each of the one or more condition states in each of the one or more identified gradable retinal images based on number of structure types and condition states in each of the one or more identified gradable retinal images. As an example, there may be “two” structure types “structure type A” and “structure type B” in a condition state, condition state “X” and hence the degree of the condition state may be “medium”. However, if there are “four” structure types such as “structure type A” and “structure type B”, “structure type C” and “structure type D” in the condition state “X”, then the degree of the condition state may be “high”. The degree of the condition state may indicate severity of the condition state in the retinal image. As an example, severity may be high, low or medium based on number of the structure types and condition states in each of the one or more identified gradable images, size of structure types and generation of new structure types.

In an embodiment, the system 101 may generate a structure map 105 indicating the identified one or more structure types. The structure map 105 may be used for easy reference by a user in identifying the structure types in the retinal images and to perform one or more corrective measures,

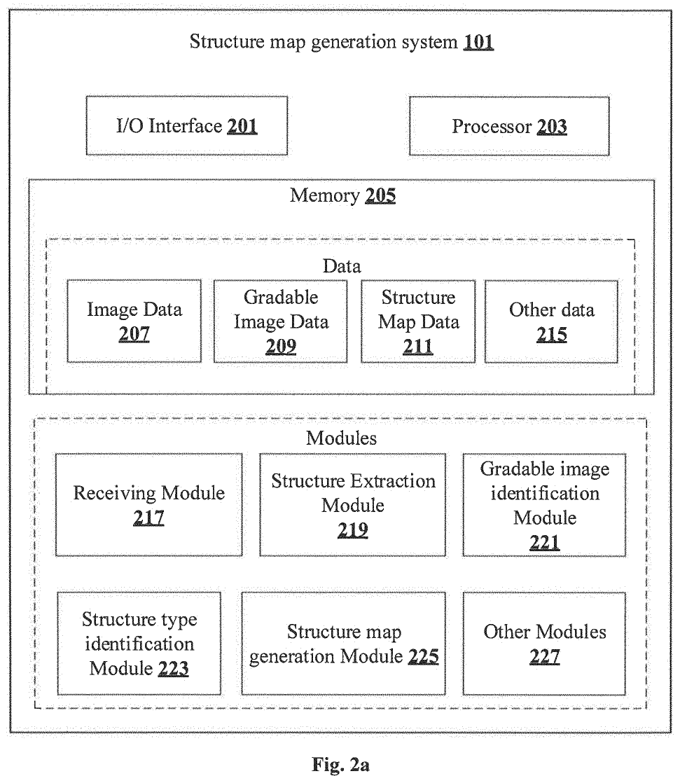

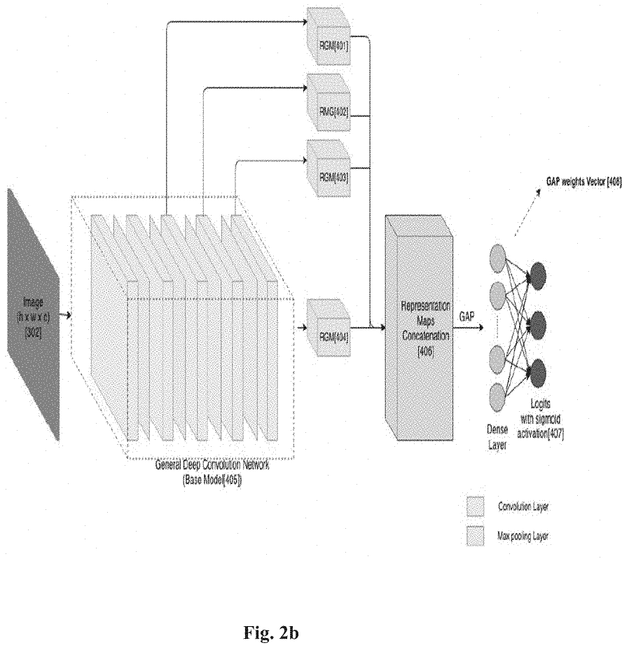

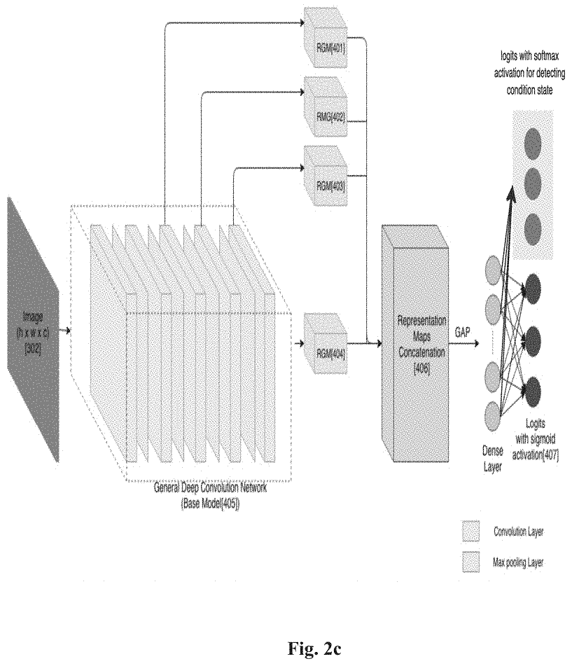

FIG. 2a shows a block diagram of a structure map generation system in accordance with some embodiments of the present disclosure.

In some implementations, the structure map generation system 101 [also referred as system] may include an I/O interface 201 and a processor 203. The I/O interface 201 may be used to receive the one or more retinal images from the data source 103 and provide generated structure map to one or more systems associated with the structure map generation system 101. The system 101 may include data and modules. As an example, the data is stored in a memory 205 configured in the system 101 as shown in the FIG. 2a. In one embodiment, the data may include image data 207, gradable image data 209, structure map data 211 and other data 215. In the illustrated FIG. 2a, modules are described herein in detail.

In some embodiments, the data may be stored in the memory 205 in form of various data structures. Additionally, the data can be organized using data models, such as relational or hierarchical data models. The other data 215 may store data, including temporary data and temporary files, generated by the modules for performing the various functions of the system 101. As an example, the other data 215 may also include data associated with pre-learnt structures in pre-stored gradable retinal images.

In some embodiments, the data stored in the memory 205 may be processed by the modules of the system 101. The modules may be stored within the memory 205. In an example, the modules communicatively coupled to the processor 203 configured in the system 101 may also be present outside the memory 205 as shown in FIG. 2a and implemented as hardware. As used herein, the term modules may refer to an Application Specific Integrated Circuit (ASIC), an electronic circuit, a processor 203 (shared, dedicated, or group) and memory 205 that execute one or more software or firmware programs, a combinational logic circuit, and/or other suitable components that provide the described functionality.

In some embodiments, the modules may include, for example, a receiving module 217, a structure extraction module 219, a gradable image identification module 221, a structure type identification module 223, a structure map generation module 225 and other modules 227. The other modules 227 may be used to perform various miscellaneous functionalities of the system 101. It will be appreciated that such aforementioned modules may be represented as a single module or a combination of different modules. The said modules when configured with the functionality defined in the present disclosure will result in a novel hardware.

Furthermore, a person of ordinary skill in the art will appreciate that in an implementation, the one or more modules may be stored in the memory 205, without limiting the scope of the disclosure.

In an embodiment, the receiving module 217 may be configured to receive one or more retinal images for screening. The one or more retinal images may be received from a data source 103. As an example, the data source 103 may be a database associated with the structure map generation system 101. In another example, the data source 103 may be a system 101 which captures the one or more retinal images and provides the one or more retinal images to the structure map generation system 101. The received one or more retinal images may be stored as the image data 207.

In an embodiment, the structure extraction module 219 may be configured to extract one or more structures in each of the one or more retinal images. Upon receiving the one or more retinal images, the structure extraction module 219 may implement a primary thresholding method to identify a predefined threshold value. Each of the one or more retinal images may be cropped based on the predefined threshold value to compensate for low quality retinal images. Further, the cropped retinal images may be processed based on blurring and image processing technique to identify a normalised image. The identified normalised image may comprise the one or more structures which are extracted by the structure extraction module 219. The extracted one or more structures may indicate one or more lesion features.

In an embodiment, the gradable image identification module 221 may be configured to identify one or more gradable or non-gradable retinal images in the received retinal images based on quality of the retinal images. The gradable image identification module 221 may identify the one or more gradable or non-gradable retinal images using a Liquid Time Constant Recurrent Neural Networks (LTCNet model [also referred as a model]. In an embodiment, only the images which are identified as gradable may be used for further processing. The identified one or more gradable retinal images may be stored as gradable image data 209. The images which are identified as non-gradable may be discarded. In an embodiment, the model may use one or more Representation Generator Module (RGMs) to identify the one or more gradable retinal images using a Convolution Neural Network (CNN) as shown in FIG. 2b. Thereafter, each RGM may apply 1×1 convolution filter on the one or more retinal images followed by a non-linear activation such as Rectified Linear Unit (ReLU) and an up-sampling layer to generate representation maps. Once the representation maps are generated, an up-sampling layer may be required to make size of the representation maps from multiple RGMs, uniform. Finally, the representation maps may be used by a softmax layer in the CNN for minimizing cross-entropy loss and improving localization performance in identifying the one or more gradable retinal images. In an embodiment, initial layers of the CNN may select low-level features in the retinal images such as edges, textures, and corners to improve the localization performance.

In an embodiment, the structure type identification module 223 may be configured to identify one or more structure types in the identified one or more gradable retinal images. The structure type identification module 223 may identify one or more structure types in the identified one or more gradable retinal images based on the extracted one or more structures in the one or more retinal images and information associated with pre-learnt structures in the pre-stored gradable retinal images. The information may comprise one or more pre-stored gradable retinal images, one or more structure types and one or more condition states associated with pre-learnt structures in the one or more pre-stored gradable retinal images. The pre-stored gradable retinal images may be obtained from the data source 103 associated with the system 101. In an embodiment, the pre-stored gradable retinal images may be annotated by annotators with structure types and condition states. As an example, the annotator may annotate “10” pre-stored gradable images with structure types and condition states. The below table 1 indicates the “10” pre-stored gradable images with the annotations. Each image may be annotated with one or more structure types and one or more condition states. As an example, the below table 1 indicates “10” pre-stored gradable images and its associated structure type and condition state being annotated. The annotated pre-stored gradable images are stored in the data source 103.

TABLE 1

| Pre-stored gradable image | Structure Type | Condition state |
|---|---|---|
| Image 1 | Hard Exudates | DR |
| Image 2 | Deep-hemorrhage | DME |
| Image 3 | Soft Exudates | DR |
| Image 4 | Microaneurysms | DME |
| Image 5 | Soft Exudates | DR |
| Image 6 | Microaneurysms | DR |
| Image 7 | Hard Exudates | ARMD |
| Image 8 | Soft Exudates | ARMD |
| Image 9 | Microaneurysms | ARMD |
| Image 10 | Soft Exudates | ARMD |

The CNN may be trained using information associated with pre-learnt structures and pre-learnt condition states in the pre-stored gradable retinal images. Based on the training and the extracted structure one or more structures, the CNN may identify the one or more structure types of retinal images in real-time. The CNN may also identify one or more condition states in each of the identified one or more gradable retinal images based on the extracted one or more structures and the information associated with the pre-learnt structures in the pre-stored gradable retinal images.

In an embodiment, the LTCNet model may be implemented to identify the structure types and condition states using the CNN as shown in FIG. 2c. As shown in FIG. 2c, the one or more gradable retinal images may be provided to the model. At first, the one or more gradable images are provided to the CNN network comprising of convolutional and max pooling layers. Thereafter, the one or more gradable images are provided to the one or more RGMs wherein the one or more RGMs generate representation maps indicating structure types. Thereafter, each RGM may apply 1×1 convolution filter on the one or more retinal images followed by a non-linear activation such as Rectified Linear Unit (ReLU) and an up-sampling layer to upscale the representation maps. Once the representation maps are generated, an up-sampling layer may be required to make size of the representation maps from multiple RGMs, uniform. The one or more representation maps are concatenated at the concatenation layer and provided to a GAP layer. At the GAP layer, an average of the representation layer is obtained, and the averaged representation map is provided to a softmax layer. At the softmax layer, the model may use the representation maps and converts the representation maps into probabilities wherein each probability indicates whether a structure type is present in the gradabale image or not. As an example, the input image may be provided to the network. The size of the input image may be 512*512*3 wherein 3 is the number of channels. Let's suppose the number of RGMs is 3. These 3 RGMs may consider the input size of 128*128*64, 64*64*256, 32*32*512 respectively. These RGMs bring all these inputs to the same representation and reduce the dimensions by applying convolution operations of 1*1 and may bring these inputs to 128*128*32, 128*128*64, 128*128*128 respectively. Now the concatenated stacked output of these will be 128*128*224, hence 224 units representing the image may be provided to the softmax/sigmoid layer for identifying the structure types and condition state by using these RGMs.

Further, in an embodiment, the pixel value for each x, y location in the representation map is calculated based on the below equation 1 which indicates position of specific structure type in the representation map.

$${M}_{cn} ( x , y ) = {\sum }_{i = 1}^{k} {W}_{i}^{c} {f}_{i n} ( x , y ) \qquad Equation 1$$

### Wherein,

Men represents representation map for a particular structure type belonging to a class C generated using the nth RGM block.

fᵢₙ(x, y) represents the representation map of the i^{th} filter from the k filters in the nth RGM output maps. Wⁱ_{c} corresponds to the i^{th} element in a weight vector for class c in the final dense Wⁱ_{c} layer connecting output from the GAP layer to the softmax layer.

In an embodiment, once the one or more structure types are identified, the system 101 may identify degree of each of the one or more condition states in each of the one or more identified gradable retinal images, the degree may indicate severity of the condition states in the retinal images. The system 101 may identify the degree based on number of structure types and condition states in each of the one or more identified gradable retinal images.

In an embodiment, the structure map generation module 225 may be configured to generate structure maps. The structure map 105 may indicate one or more structure types in the one or more retinal images received by the structure map generation system 101. The structure map 105 be stored as structure map data 211.

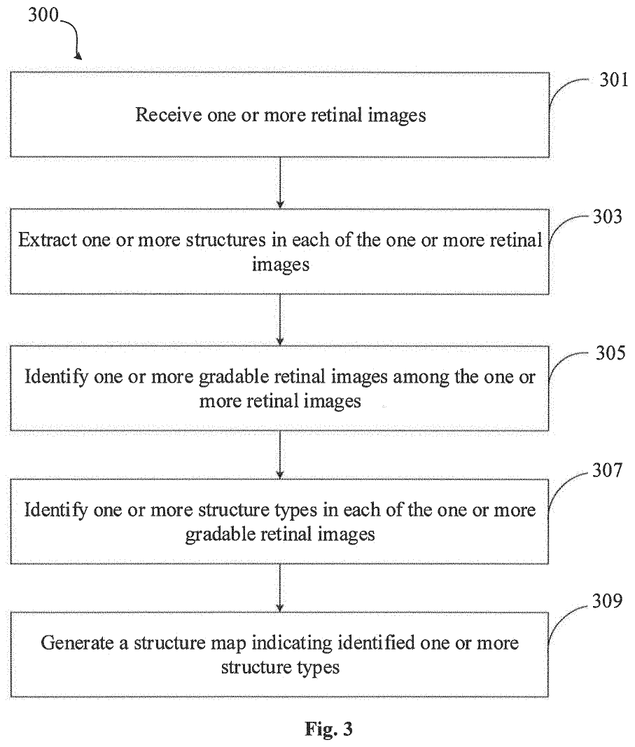

FIG. 3 shows a flowchart illustrating a method for generating a structure map for retinal images in accordance with some embodiments of the present disclosure.

As illustrated in FIG. 3, the method includes one or more blocks illustrating a method for generating a structure map 105 for retinal images. The method may be described in the general context of computer executable instructions. Generally, computer executable instructions can include routines, programs, objects, components, data structures, procedures, modules, and functions, which perform specific functions or implement specific abstract data types.

The order in which the method is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the method may include receiving one or more retinal images for screening of one or more condition states and one or more structure types. As an example, the one or more structure types may include, but is not limited to, Microaneurysms, deep-hemorrhage, Hard Exudates, Soft Exudates and any other structure types which may be identified in the retinal images. As an example, the one or more condition states may include, but is not limited to, Diabetic Retinopathy (DR), Age-Related Macular Degeneration (ARMD), and Diabetic Macular Edema (DME) and any other condition states which may be identified in the retinal images.

At block 303, the method may include identifying one or more gradable retinal images from the received one or more retinal images. The one or more gradable retinal images may be identified based on quality of the one or more retinal images. The one or more gradabale retinal images may be identified using a LTCNet model which is trained with cross entropy loss. The one or more gradable retinal images are provided for further processing to block 305. The one or more non gradable retinal images may be discarded.

At block 305, the method may include extracting one or more structures in the one or more retinal images. The one or more structures may indicate lesion features in the retinal images. Each of the one or more retinal images may be cropped based on the predefined threshold value to compensate for low quality retinal images. Further, the cropped retinal images may be processed based on blurring and image processing technique to identify a normalised image. The identified normalised image may comprise the one or more structures which are extracted.

At block 307, the method may include identifying one or more structure types in each of the identified one or more gradable retinal images. The one or more structure types may be identified based on the extracted one or more structures and information associated with pre-learnt structures in the pre-stored gradable retinal images. Annotators may annotate one or more structures and one or more condition states in the pre-stored gradable retinal images. The CNN may be trained using the information associated with the pre-learnt structures and the condition states in the pre-stored gradable retinal images. The trained CNN may identify the one or more structure types and the condition states in the one or more gradable retinal images based on the extracted one or more structures and information associated with the pre-learnt structures and the condition states.

At block 309, the method may include generating a structure map. The structure map 105 generated may indicate the one or more structure types in each of the one or more retinal images. The generated structure map 105 may help to easily identify the one or more structure types in the retinal images.

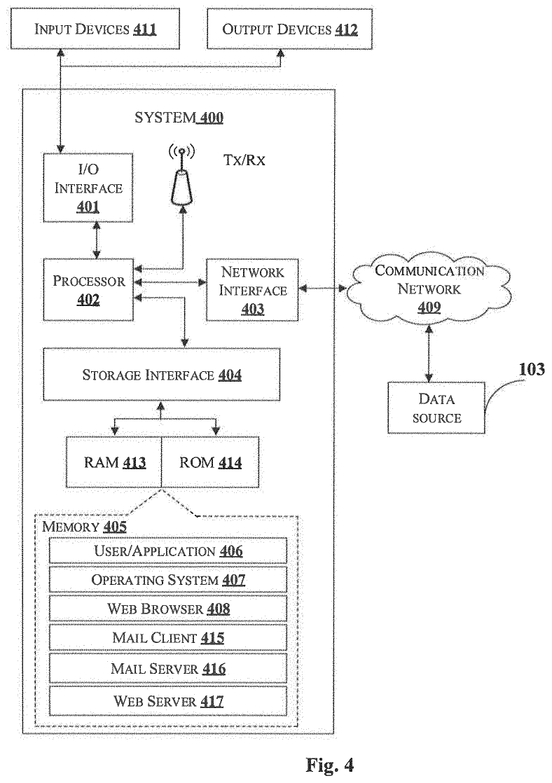

FIG. 4 illustrates a block diagram of an exemplary computer system 400 for implementing embodiments consistent with the present disclosure. In an embodiment, the computer system 400 may be a structure map generation system 101, which is used for generating a structure map for retinal images. The computer system 400 may include a central processing unit (“CPU” or “processor”) 402. The processor 402 may comprise at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 511 and 412. In some implementations, the I/O interface 401 may be used to connect to a database 103 to receive retinal images.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 409 can be implemented as one of the several types of networks, such as intranet or Local Area Network (LAN) and such within the organization. The communication network 409 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, a web browser 408, mail client 415, mail server 416, web server 417 and the like. In some embodiments, computer system 400 may store user/application data 406, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED FIAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system 500, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

### Advantages of the Present Disclosure

The present disclosure provides method and system for generating structure map for retinal images which comprises information of structure types and condition states in the retinal images for easy identification of the structure types or condition states by a user.

The present disclosure accurately identifies structure types and condition states using a Convolution Neural Network (CNN) technique and hence avoids Inter-Observer Variability (IOV) between ophthalmologists who annotates structure types and condition states.

The RGM model implemented in the present disclosure requires minimum number of changes required for integrating any number of different condition states.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Referral Numerals:

| Reference Number | Description |
|---|---|
| 100 | Exemplary architecture |
| 101 | Structure map generation system |
| 103 | Data source |
| 105 | Structure map |
| 201 | I/O Interface |
| 203 | Processor |
| 205 | Memory |
| 207 | Image Data |
| 209 | Gradable image data |
| 211 | Structure map data |
| 215 | Other data |
| 217 | Receiving module |
| 219 | Structure extraction module |
| 221 | Gradable image identification module |
| 223 | Structure type identification module |
| 225 | Structure map generation module |
| 227 | Other modules |
| 400 | Exemplary computer system |
| 401 | I/O interface of the exemplary computer system |
| 402 | Processor of the exemplary computer sy stem |
| 403 | Network interface |
| 404 | Storage interface |
| 405 | Memory of the exemplary computer system |
| 406 | User/Application |
| 407 | Operating system |
| 408 | Web browser |
| 409 | Communication network |
| 411 | Input devices |
| 412 | Output devices |
| 413 | RAM |
| 414 | ROM |
| 415 | Mail Client |
| 416 | Mail Server |
| 417 | Web Server |

1. A method of generating a structure map for retinal images, the method comprising:
receiving, by a structure map generation system, one or more retinal images;
extracting, by the structure map generation system, one or more structures in each of the one or more retinal images;
identifying, by the structure map generation system, one or more gradable retinal images among the one or more retinal images;
identifying, by the structure map generation system, one or more structure types in each of the identified one or more gradable retinal images based on the extracted one or more structures and information associated with pre-learnt structures in pre-stored gradable retinal images; and
generating, by the structure map generation system, a structure map indicating the one or more structure types for each of the one or more gradable retinal images.

2. The method as claimed in claim 1 further comprises identifying one or more condition states in each of the identified one or more gradable retinal images based on the extracted one or more structures and the information associated with the pre-learnt structures in the pre-stored gradable retinal images.

3. The method as claimed in claim 2 further comprises identifying degree of each of the one or more condition states in each of the one or more identified gradable retinal images based on number of structure types and the condition states in each of the one or more identified gradable retinal images.

4. The method as claimed in claim 2, wherein the one or more structure types and the one or more condition states in each of the identified one or more gradable retinal images is identified using a Convolution Neural Network (CNN), wherein the CNN is trained using the information associated with the pre-learnt structures in the one or more pre-stored gradable retinal images.

5. The method as claimed in claim 1, wherein the information comprises one or more pre-stored gradable retinal images, one or more structure types and one or more condition states associated with pre-learnt structures in the one or more pre-stored gradable retinal images.

6. A structure map generation system for generating a structure map for retinal images, the structure map generation system comprising:
a processor; and
a memory communicatively coupled to the processor, wherein the memory stores the processor-executable instructions, which, on execution, causes the processor to:
receive one or more retinal images;
extract one or more structures in each of the one or more retinal images;
identify one or more gradable retinal images among the one or more retinal images;
identify one or more structure types in each of the identified one or more gradable retinal images based on the one or more structures and information associated with pre-learnt structures in pre-stored gradable retinal images; and
generate a structure map indicating the one or more structure types for each of the one or more gradable retinal images.

7. The structure map generation system as claimed in claim 6, wherein the processor identifies one or more condition states in each of the identified one or more gradable retinal images based on the one or more structures and the information associated with the pre-learnt structures in the pre-stored gradable retinal images.

8. The structure map generation system as claimed in claim 7, wherein the processor identifies degree of each of the one or more condition states in each of the one or more identified gradable retinal images based on number of structure types and the condition states in each of the one or more identified gradable retinal images.

9. The structure map generation system as claimed in claim 7, wherein the processor identifies the one or more structure types and one or more condition states in each of the identified one or more gradable retinal images using a Convolution Neural Network (CNN), wherein the CNN is trained using the information associated with the pre-learnt structures in the one or more pre-stored gradable retinal images.

10. The structure map generation system as claimed in claim 6, wherein the information comprises one or more pre-stored gradable retinal images, one or more structure types and one or more condition states associated with pre-learnt structures in the one or more pre-stored gradable retinal images.
